(19) United States
(12) Patent Application Publication
(10) Pub. No.: US 2026/0016558 A1
(43) Pub. Date: Jan. 15, 2026

(54) Real-Time Location System According to Node Synchronization Captured During Time Difference of Arrival Ranging

(71) Applicant: Link Labs, Inc, Annapolis, MD (US)

(72) Inventor: Mark O. BLOECHL, Annapolis, MD (US)

(73) Assignee: Link Labs, Inc., Annaplis, MD (US)

(21) Appl. No.: 18/767,413

(22) Filed: Jul. 9, 2024

(51) Int. Cl. G01S 3/50; H04W 56/00

(52) U.S. Cl. CPC G01S 3/50; H04W 56/004

(57) ABSTRACT

Provided are a system and method for optimizing manner of time difference of arrival (TDOA) synchronization among affiliated wireless communications nodes. During a TDOA frame in which the affiliated nodes broadcast respective signals, at least one of the affiliated nodes can capture such signals of others of the nodes to calculate a synchronization factor enabling perceived signal synchronicity when location according to a TDOA framework is determined. The synchronization factor can be used in location determination according to a TDOA frame, thereby affording at least dual synchronization and location measurement to occur for such a TDOA frame and those frames that follow. In these ways, efficiency for TDOA operations overall is enhanced through streamlining of synchronization and location measurement operations affording conservation of node energy and increased availability of synchronization evaluation.

### FIELD OF THE DISCLOSURE

Disclosed embodiments relate to wireless communications systems and the operation thereof when implementing time difference of arrival (TDOA) measurement, and more specifically, to consolidating synchronization among affiliated wireless nodes when signaling underlying that measurement occurs.

### BACKGROUND

Wireless communications protocols which are operative to enable the exchange of information between objects are varied in both their purposes and capabilities. Among such protocols are BLUETOOTH, BLUETOOTH LOW ENERGY (BLE), THREAD, and ULTRA-WIDEBAND (UWB). Each of such protocols can be advantageous for their respective utility, where that utility can be dictated by certain considerations. For example, BLE may have various utility in circumstances where energy consumption is of paramount importance given that operable nodes lay dormant in between on-air connections. As another example, nodes which are operable according to the UWB protocol can achieve a far narrower scope of ranging estimation than that which can be obtained when implemented by BLE governed nodes. Yet, due to such superiority in ranging, energy consumption by UWB nodes may be at a premium. This is particularly the case where localization according to UWB is achieved according to a time difference of arrival (TDOA) regime as against localization using time of flight (TOF), i.e., two-way ranging (TWR), where the distance between nodes is deduced from the roundtrip flight time of signaling therebetween. In this regard, it is well-recognized that ranging errors in real-time location systems (RTLS) implementing TDOA can significantly skew desired accuracy when contributory ranging nodes are not synchronized in their respective transmissions of ranging signaling. In other words, since TDOA determines respective node location as a result of analysis of arrival times of spatially separated signaling, it is necessary to time synchronize that signalizing to ensure analysis of a same time signal. Relative to such nodes for which such synchronization is necessary, it can be beneficial to strive to achieve that synchronization in a most efficient manner such that node construction and operational efficiency can be optimized.

### SUMMARY

It is to be understood that both the following summary and the detailed description are exemplary and explanatory and are intended to provide further explanation of the present embodiments as claimed. Neither the summary nor the description that follows is intended to define or limit the scope of the present embodiments to the particular features mentioned in the summary or in the description. Rather, the scope of the present embodiments is defined by the appended claims.

Embodiments herein may include a system and commensurate method providing a real-time location system (RTLS), including, a beacon pod comprising a master beacon (MB) and at least first through third slave beacons (SBs) in communication with each other during a time difference of arrival (TDOA) frame, the MB determining a signal synchronization factor as between the MB and each respective SB while the TDOA frame occurs.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. Embodiments herein will be more particularly described in conjunction with the following drawings wherein:

FIG. 1 is an illustration of a system providing wireless communications in accordance with embodiments herein; and

FIG. 2 is an illustration of components that can comprise the system of FIG. 1 in order to enable location determination according to a time difference of arrival (TDOA) framework;

FIG. 3 is an exploded view of a beacon pod comprising at least one of the components according to FIG. 2, and which illustrates a manner of synchronization among affiliated beacons of a beacon pod during a TDOA frame;

FIG. 4 is a schematic diagram illustrating communications among affiliated beacons of the beacon pod when accomplishing the synchronization according to FIG. 3; and

FIG. 5 is a sequence diagram illustrating, in accordance with the synchronization illustrated in FIGS. 3-4, TDOA ranging conducted across one or more TDOA frames.

### DETAILED DESCRIPTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including.” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedure, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

The word “network” is used herein to mean one or more conventional or proprietary networks using an appropriate network data transmission protocol, or other specification and/or guidelines which may be applicable to the transfer of information. Examples of such networks include, PSTN, LAN, WAN, WiFi, LTE, CBRS, and the like.

The phrase “wireless device” is used herein to mean one or more conventional or proprietary devices using radio frequency transmission techniques or any other techniques enabling the transfer of information. Examples of such wireless devices include cellular telephones, desktop computers, laptop computers, handheld computers, electronic games, portable digital assistants, MP3 players, DVD players, or the like.

Bluetooth Low Energy (BLE) networking enables detection and connection among devices that generally do not require continuous connection therebetween in order for an exchange of information in the form of data to occur. Yet, such devices depend upon extended battery life in order that the opportunity for such an exchange may continue to reliably exist. The devices themselves vary in their construction, whether, for example, a sensor, a cellphone, a network access point, or some other object configured to enable and/or provide BLE communication(s) and which is either stationary or mobile, such as a BLUETOOTH tag. In the context of BLE networking, such devices are prescribed by the BLUETOOTH Core Specification 4.0 and are compatible with IEEE 802.15.1, as appropriate.

As will be discussed, embodiments herein may encompass signaling on one or more devices equipped according to an “XLE” wireless communications protocol, wherein such protocol is a low energy consumption protocol such as BLE or THREAD, and otherwise a UWB protocol, or, for example, on a combination of such protocols relative to selective operations between system nodes (i.e., wireless communications nodes (WCNs)) that exchange such signaling. When conducting signaling that is available for ranging among nodes represented by the various devices, it can be advantageous to coordinate use of the combination of protocols to reduce energy consumption at the nodes. For instance, and as will be understood from the discussion(s) below, such coordination can be implemented in accordance with an arranged sequencing of discrete use of the protocols.

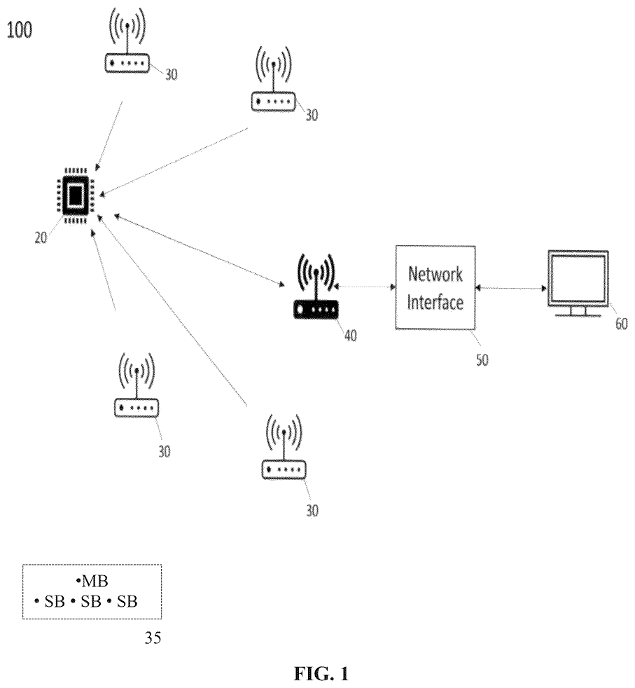

Referring to FIG. 1, a description of a communications system 100 according to an embodiment is provided. System 100 and its components may each be configured to be operable in accordance with one or more of XLE and UWB protocols, such that each of the aforementioned components are configured for communications according to a selected one of such protocols at a first time and the other of such protocols at a second time. System 100 typically includes multiple tags 20—only one is shown in FIG. 1 for clarity. Tag 20 may be attached to or associated with a particular object for the purposes of tracking a changing location of that object. Tags 20 are capable of wirelessly communicating with other components of system 100 as more fully described herein. System 100 also includes a plurality of beacons 30 which also communicate wirelessly with other components of system 100 such as with tags 20. Beacons 30 are located at very specific geographic coordinates within the area within which objects are to be tracked. Beacons 30 are installed in these locations and during the time of installation, their specific locations are entered into system 100 so that system 100 is always aware of the known exact physical locations of each such beacon 30. In some implementations, one or more of the beacons 30 shown in FIG. 1 may be aggregated into a beacon pod 35 comprising a master beacon (MB) and one or more, optionally three (3), slave beacons (SBs) for purposes as later described herein.

System 100 may also include one or more access points 40. These access points 40 may also serve in the same capacity as one or more beacons 30 in that their location is known to system 100 and such that they may communicate with tags 20 as described herein for the purpose of location determination as more fully described herein. In addition, access points 40, if present, also provide a connection to network interface 50 which permits data to be shared with and received from other networks such as the internet. This functionality may alternatively be provided by one or more beacons 30 in lieu of access point 40. In one embodiment, data is transmitted and received via backhaul to the internet such that a cloud based application may be accessed by a user via client 60 to view object location information and also to allow the user to configure various aspects related to the functionality of system 100.

Tags 20 are responsible for executing any coordinate location determination process locally and then reporting the location determination to system 100 via a communication to an access point 40 (or a beacon 30). In an embodiment, each tag 20 may individually report such a corresponding location determination via its own respective backhaul. See, for example, U.S. Pat. No. 10,264,436 entitled, “BLE NETWORKING SYSTEMS AND METHODS PROVIDING CENTRAL AND PERIPHERAL ROLE REVERSAL WITH INDEPENDENT PERIPHERAL NETWORK CONNECTIVITY,” which is commonly owned by the assignee of the present application and incorporated by reference herein.

In this regard and when still referring to FIG. 1, XLE communications between a tag 20 and a beacon 30 may occur according to a “role reversal” where the tag 20 is responsible for determining its location, i.e., after first receiving a beacon broadcast that can be a trigger for the location determination process to begin at the tag 20. An exemplary discussion of one or more aspects which are descriptive of the reversal are provided in U.S. Pat. No. 10,708,970 entitled, “BLE NETWORKING SYSTEMS AND METHODS PROVIDING CENTRAL AND PERIPHERAL ROLE REVERSAL WITH ENHANCED PERIPHERAL LOCATION DETERMINATION USING CONSTANT TONE EXTENSION ANALYSIS FOR A SAME CHANNEL,” which is commonly owned by the assignee of the present application and incorporated by reference herein. Analogously, a respective tag 20 and beacon 30 pair may, according to embodiments herein, execute such same role reversal so as to thereafter employ UWB communications following the aforesaid XLE communications.

It is to be understood by one of ordinary skill in the art that each of the tag 20 and each beacon 30 may be implemented by all appropriate software and/or hardware for carrying out location technologies included in the discussion herein, e.g., TDOA measurements according to a UWB protocol.

In the carrying out of processes according to these technologies, it can be of the utmost benefit to weigh energy consumption according to wireless communications protocols with which each of a tag 20 and a beacon 30 (or beacons 30 of a beacon pod 35) may be equipped. Such weighing, for instance, may be impacted by certain constraints of one or more of these protocols, e.g., line of sight impediments which are characteristic of UWB. That is, it can be beneficial to first attempt communications between nodes according to a protocol, such as XLE, which is freed of these and other impediments when first engaging in communications between nodes. In a case when the communications are thus established, further operable protocol, such as UWB, can then be employed. In this way, implementation of the initial communication can reduce energy consumption (e.g., by avoiding line of sight impediment(s)) where, for instance and as is understood, XLE communication can be more economical than that of UWB in a process of, for example, communicating one or more parameters governing sequencing for a TDOA frame.

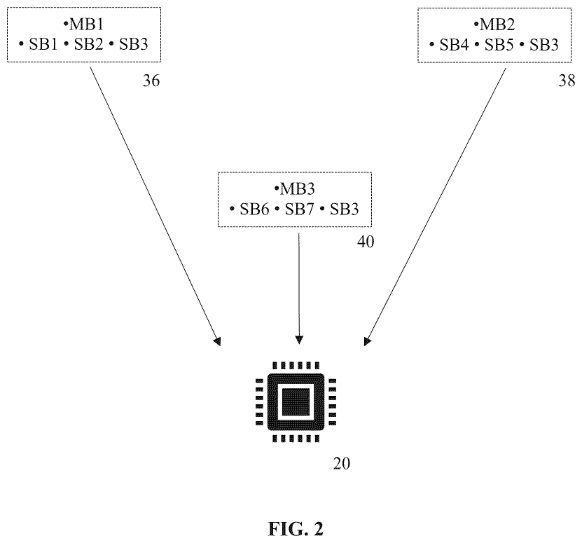

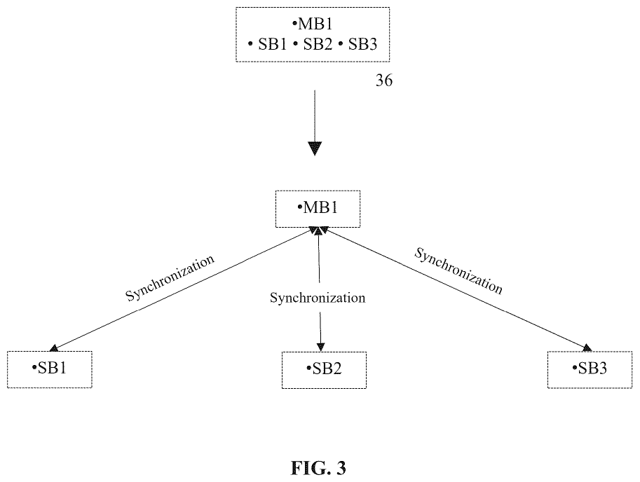

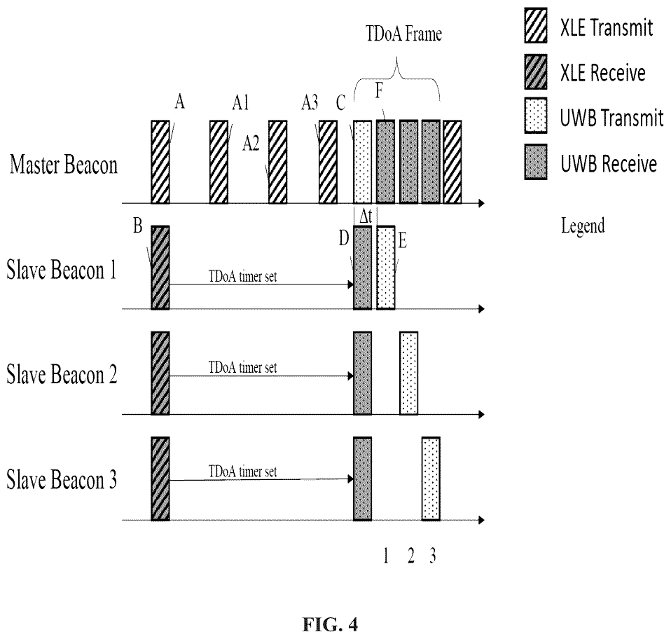

On the basis of such economy, and where clock synchronization among nodes is crucial to accuracy in localization according to a TDOA regime, it can be efficient, as will be understood from discussion below in regard to FIGS. 3-4, to coordinate communications achieving such nodes comprising beacons of a beacon pod across separate wireless communications protocols (e.g., XLE including BLE or THREAD as protocol 1, and UWB as protocol 2). As background for one or more implementations of the aforementioned coordination as will be discussed hereinbelow, the reader is referred to FIG. 2. Therein, TDOA ranging between the tag 20 and beacon pod 35 of FIG. 1 is expanded to include multiple further opportunities for such ranging relative to beacon pods 36, 38, and 40 comprising SB1, SB2, and SB3; SB4, SB5, and SB3; and SB6, SB7, and SB3, respectively. As will be observed, the aforementioned beacon pods may have in common exemplary SB3, such that the multiplexing for such SB may be implemented according to expediting of synchronization and TDOA ranging afforded by relevant scheduling therefor (see FIGS. 3-4) as broadcast by respective MBs including MB1, MB2, and MB3. Herein, it will be understood that the number of beacon pods and their constituent beacons, as well as the number of tags are merely exemplary as more than those shown may be contemplated and be in satisfaction of the discussed implementations.

In referring to FIGS. 3-4, there is illustrated, relative to exemplary beacon pod 36 having affiliated MB1, SB1, SB2, and SB3, a manner of achieving synchronization of the SBs with the MB to ensure receipt of a same time signal at, for instance, a tag 20 as is shown in FIG. 1. In particular, the synchronization process among the MB and each SB (indicated by the double arrows in FIG. 3) can occur during a TDOA frame and at the particular time at which a SB transmits to such a tag 20.

In these regards and when referring specifically to FIG. 4 illustrating MB-SB synchronization during a TDOA frame, there is shown the specific coordination of signaling on protocols 1 and 2 to effectuate the TDOA frame. Therein, and for communications subsequent to initialization of the system 100, a constituent MB of, for example, beacon pod 36, broadcasts its signaling at “A” for receipt at each of the SBs 1-3 at iterations of “B.” As indicated, the broadcast is transmitted and received according to protocol 1, or XLE, to economize power consumption and can be repeated at A1-A3 so as to enhance reliability of and opportunity for capture. In particular, such a broadcast can define, according to the MB's determination, a TDOA frame schedule, i.e., when the TDOA ranging frame will begin. As such, each SB1-SB3 is accorded the schedule (shown as TDoA timer set), and upon receipt thereof will lay dormant in a sleep state and awaken per the schedule. Upon expiration of the schedule timing (i.e., a countdown to the TDOA frame), the MB may execute the TDOA frame via broadcast of its signal at “C” according to protocol 2, or UWB, for receipt by each of the SBs 1-3 at iterations of “D” on that protocol. Once received, each of the SBs 1-3 reverts to a sleep state and awakens at a time of transmission (to the tag 20 of FIG. 1, for example) also prescribed by the TDOA schedule transmitted by the MB at “A.” In particular, such a time of transmission may be represented as an offset from the MB's broadcast at “C,” (i.e., the difference in time from when the MB broadcasted and when SB signaling is schedule) as indicated by Δt corresponding to SB1, and as will be understood, 2Δt and 3Δt respectively corresponding to SB2 and SB3. As such, each time represented by a respective Δt may be understood as the slot of the TDOA schedule accorded to a particular SB for ranging with the tag 20 (each slot being shown respectively at “1,” “2,” and “3”). Once the MB has completed transmission of its broadcast at “C,” each SB is configured to await and begin initiation of its respective transmission during the TDOA frame.

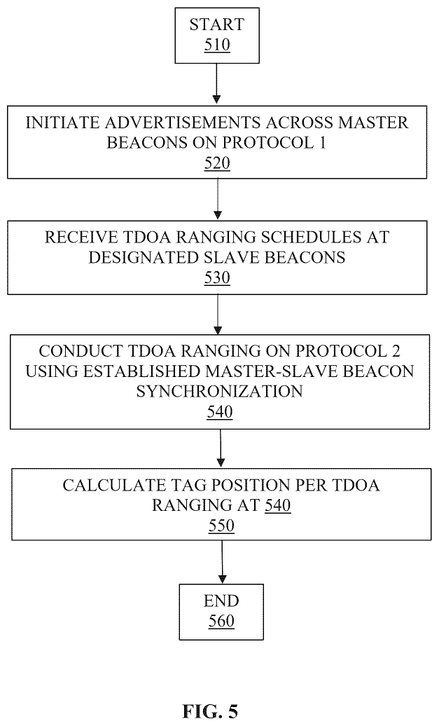

In this regard, completion of the MB broadcast at “C” to the affiliated SBs (e.g., by media access control (MAC) address) serves not only to equip each SB to carry out (i.e., execute respective sleep/awaken cycling) the TDOA frame schedule, but also to allow the MB to prepare for initiation of synchronization with each of the SBs. That is, as is shown in FIG. 4, once the MB has executed its broadcast at “C,” its protocol 2, or UWB, operations are transitioned to a receive mode at iterations thereof as are indicated at “F.” In this receive mode, the MB is thus enabled, during the TDOA frame, to acquire each of the SB transmissions “E” according to their respectively designated slots “1”-“3.” Accordingly and because the MB is in possession of its transmit timing at “C” and each of timings for the corresponding transmission slots of SBs 1-3, it is enabled to, as will be understood by one of ordinary skill in the art, determine the roundtrip time, as thus the corresponding one-way propagation delay for signaling to a respective beacon. As such, the one-propagation delay can represent, as is further explained with reference to FIG. 5, a synchronization factor by which signaling for each of the SBs 1-3 can be adjusted by a tag 20 when determining its location according to a TDOA regime.

In this regard and when referring to FIG. 5 beginning at 510, one or more exemplary MBs associated with pods 35, 36, 38, and 40 are configured to, at 520, initiate respective signaling (i.e., a single broadcast to each SB of a pod) on protocol 1, or XLE. As has been explained above, such broadcasts can be directed to the affiliated SBs according to their respective MAC addresses. In connection with receipt of MB broadcasts at “B” of FIG. 4, each SB of a given pod can, at 530, receive a TDOA ranging schedule defined by a MB broadcast and which sets forth (1) when a respective SB ought to awaken in order to receive a MB broadcast beginning a TDOA frame and (2) when such an SB ought to further awaken to meet its TDOA ranging slot (see “E” in FIG. 4). In accordance with that ranging slot, each SB (and where the MB has already transmitted at, for example, “C” in FIG. 4 for receipt by the tag 20), can respectively transmit to the tag 20 so as to complete a TDOA ranging frame transmission cycle therefor. As referenced with respect to FIG. 4, such TDOA frame is conducted on protocol 2, or UWB, at 540 according to synchronization between the MB and each of its affiliated pod SBs. Here, such synchronization is, for each cycle of MB-SB interaction at “E” and “F” of FIG. 4, determined in accordance with a synchronization factor calculated by the MB and stored thereby. In this regard, such a synchronization factor can be “established” as a result of an aforementioned cycle of MB-SB interaction occurring in a prior TDOA frame relative to such frame in which TDOA ranging is currently conducted. That is, such an established synchronization factor can represent the one-way propagation delay to a respective SB, where, for respective TDOA frames conducted in close temporal proximity, an accuracy of the factor may be sufficient to represent perceived synchronization at the tag 20 in view of unaltering placement of beacon pod members. In particular, the synchronization factor (i.e., the one-way propagation delay from a MB to a given SB, or roundtrip time divided by 2) can be given by:

$${synch}_{n} = \frac{{t}_{rx \_ n} - {t}_{tx} - {rtt}_{n}}{2} ,$$

in which t_{rx_n} represents the MB's receive timestamp of a UWB signal from the SB, tₜₓ represents the MB's UWB signal timestamp, and rttₙ represents the SB's receive to transmit time, as included in the UWB response payload (such as at “E” in FIG. 4). Accordingly, in view of the MB having established and stored the respective synchronization factors for its affiliated SBs, the tag 20 can, in and for a current TDOA frame, calculate at 550 its position relative to one or more of the herein discussed beacon pods for which it receives transmissions as it traverses a given landscape. More specifically, the tag 20 can conduct that calculation according to a conventional TDOA analysis since, as will be understood, the established synchronization factor corresponding to each affiliated SB of a pod is transmitted to the tag 20 (see, e.g., FIG. 2) according to a MB transmission (see “C” in FIG. 4) beginning a TDOA frame. Whereas each of the slotted transmissions from SBs (see “1”-“3” of FIG. 4) are received by the tag 20 (not shown in FIG. 4 in the interest of clarity of demonstrating MB-SB synchronization), the tag 20, knowing its receive timestamp of the MB broadcast and those respective timestamps of the SB broadcasts, can then perceive a same MB-SB transmission signal by executing its TDOA analysis to subtract out the respective synchronization factor and magnitude of Δt from its receive timestamp for a received, given SB transmission. As such, operations can conclude at 560 and thereafter reinitiate for a subsequent TDOA frame (indicated, for example) by the MB's XLE transmit following the TDOA depicted in FIG. 4.

Relative to the above synchronization and TDOA schedule distributed according to MB broadcast(s), one of ordinary skill in the art will appreciate the realization of multiple advantages enabled by the distribution. For instance, given that the TDOA schedule is transmitted on low power consumption protocol, such as BLE, energy resources at each of the beacon pod members can be necessarily reserved for UWB operations in a TDOA frame. Moreover, and according to such a schedule, synchronization, according to a synchronization factor determined by a MB, can be consolidated with that TDOA frame. That is, the TDOA frame can be the basis for dual modalities including synchronization as well as TDOA ranging, thereby optimizing usage of MB and SB broadcasts which, otherwise, could have been targeted for those modalities separately. Additionally, embodiments disclosed herein and prescribing the aforementioned consolidation can provide increased availability of opportunity for synchronization, and thus the accuracy thereof, throughout successively occurring TDOA frames so as to, for instance, thwart opportunity for synchronization skewing owing to, for example, interference with signaling that may occur in an environment in which one or more beacon pods are located. In this regard, location determination by a tag can be optimized since the tag can narrow its location via gradient descent (see U.S. Pat. No. 10,986,467, entitled, “APPARATUS AND METHOD FOR GEOLOCATING A TAG RELATIVE TO A THRESHOLD VIA PHASE-BASED TIME DIFFERENCE OF ARRIVAL FRAMEWORK, which is commonly owned by the assignee of the present application and incorporated by reference herein) when in receipt of multiple MB broadcasts to ascertain whether it is within a perimeter of (i.e., most near) a respective beacon pod.

The present embodiments are not limited to the particular embodiments illustrated in the drawings and described above in detail. Those skilled in the art will recognize that other arrangements could be devised. The present embodiments encompass every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the present embodiments have been described with reference to specific illustrative embodiments, modifications and variations of the present embodiments may be constructed without departing from the spirit and scope of the present embodiments as set forth in the following claims.

While the present embodiments have been described in the context of the embodiments explicitly discussed herein, those skilled in the art will appreciate that the present embodiments are capable of being implemented and distributed in the form of a computer-usable medium (in a variety of forms) containing computer-executable instructions, and that the present embodiments apply equally regardless of the particular type of computer-usable medium which is used to carry out the distribution. An exemplary computer-usable medium is coupled to a computer such the computer can read information including the computer-executable instructions therefrom, and (optionally) write information thereto. Alternatively, the computer-usable medium may be integral to the computer. When the computer-executable instructions are loaded into and executed by the computer, the computer becomes an apparatus for practicing the embodiments. For example, when the computer-executable instructions are loaded into and executed by a general-purpose computer, the general-purpose computer becomes configured thereby into a special-purpose computer. Examples of suitable computer-usable media include: volatile memory such as random access memory (RAM); nonvolatile, hard-coded or programmable-type media such as read only memories (ROMs) or erasable, electrically programmable read only memories (EEPROMs); recordable-type and/or re-recordable media such as floppy disks, hard disk drives, compact discs (CDs), digital versatile discs (DVDs), etc.; and transmission-type media, e.g., digital and/or analog communications links such as those based on electrical-current conductors, light conductors and/or electromagnetic radiation.

Although the present embodiments have been described in detail, those skilled in the art will understand that various changes, substitutions, variations, enhancements, nuances, gradations, lesser forms, alterations, revisions, improvements and knock-offs of the embodiments disclosed herein may be made without departing from the spirit and scope of the embodiments in their broadest form.

What is claimed is:

1. A real-time location system (RTLS), comprising:
a beacon pod comprising a master beacon (MB) and at least first through third slave beacons (SBs) in communication with each other during a time difference of arrival (TDOA) frame, the MB determining a signal synchronization factor as between the MB and each respective SB while the TDOA frame occurs.

2. The RTLS of claim 1, wherein:
the TDOA frame and the communication therebetween the MB and the SBs is defined by a predetermined schedule for the TDOA frame transmitted from the MB to each of the SBs on a first protocol.

3. The RTLS of claim 2, wherein:
the TDOA frame is conducted on a second protocol comprising ULTRA-WIDEBAND (UWB).

4. The RTLS of claim 2, further comprising:
at least one tag; and
wherein the predetermined schedule for the TDOA frame defines (a) timing for a transmission by the MB to each of the at least one tag and the SBs on a second protocol comprising ULTRA-WIDEBAND (UWB), and (b) timing for a transmission from each SB to the at least one tag on the second protocol.

5. The RTLS of claim 4, wherein:
during the transmissions from each SB to the at least one tag, the MB receives said transmissions from each SB to the at least one tag on the second protocol.

6. The RTLS of claim 5, wherein:
based on the timing for the transmission by the MB to each of the at least one tag and the SBs on the second protocol and the receipt by the MB of the transmissions from each SB to the at least one tag on the second protocol, the MB determines a respective synchronization factor as between the transmission by the MB to the SBs and each transmission received by the MB from a respective SB.

7. The RTLS of claim 6, wherein:
each respective synchronization factor corresponds to a one-way propagation delay from the MB to a respective SB.

8. The RTLS of claim 7, wherein:
the at least one tag calculates, according to a TDOA analysis, a location thereof based on the respective synchronization factors and respective differences between the timings for the transmissions by the MB to each of the at least one tag and the SBs on the second protocol and the timings for the transmissions from the SBs to the at least one tag on the second protocol.

9. A method of operating a real-time location system (RTLS), comprising:
providing a beacon pod comprising a master beacon (MB) and at least first through third slave beacons (SBs) in communication with each other during a time difference of arrival (TDOA) frame; and
determining, by the MB, a signal synchronization factor as between the MB and each respective SB while the TDOA frame occurs.

10. The method of claim 9, wherein:
the TDOA frame and the communication therebetween the MB and the SBs is defined by a predetermined schedule for the TDOA frame transmitted from the MB to each of the SBs on a first protocol.

11. The method of claim 10, wherein:
the TDOA frame is conducted on a second protocol comprising ULTRA-WIDEBAND (UWB).

12. The method of claim 10, further comprising:
providing at least one tag; and
wherein the predetermined schedule for the TDOA frame defines (a) timing for a transmission by the MB to each of the at least one tag and the SBs on a second protocol comprising ULTRA-WIDEBAND (UWB), and (b) timing for a transmission from each SB to the at least one tag on the second protocol.

13. The method of claim 12, wherein:
during the transmissions from each SB to the at least one tag, receiving, by the MB, said transmissions from each SB to the at least one tag on the second protocol.

14. The method of claim 13, wherein:
based on the timing for the transmission by the MB to each of the at least one tag and the SBs on the second protocol and the receipt by the MB of the transmissions from each SB to the at least one tag on the second protocol, determining, by the MB, a respective synchronization factor as between the transmission by the MB to the SBs and each transmission received by the MB from a respective SB.

15. The method of claim 14, wherein:
each respective synchronization factor corresponds to a one-way propagation delay from the MB to a respective SB.

16. The method of claim 15, wherein:
calculating, by the at least one tag according to a TDOA analysis, a location thereof based on the respective synchronization factors and respective differences between the timings for the transmissions by the MB to each of the at least one tag and the SBs on the second protocol and the timings for the transmissions from the SBs to the at least one tag on the second protocol.
